(19) United States
(12) Patent Application Publication
(10) Pub. No.: US 2019/0058805 A1
(43) Pub. Date: Feb. 21, 2019

(54) IMAGE PROCESSING APPARATUS, AND METHOD OF CONTROLLING THE SAME

(71) Applicant: CANON KABUSHIKI KAISHA, Tokyo (JP)

(72) Inventor: Naoki Ito, Tokyo (JP)

(21) Appl. No.: 16/046,652

(22) Filed: Jul. 26, 2018

(30) Foreign Application Priority Data
Aug. 18, 2017 (JP) 2017-158138

(51) Int. Cl. H04N 1/00; H04N 1/04

(52) U.S. Cl. CPC H04N 1/00816; H04N 1/00413; H04N 1/0417

(57) ABSTRACT

An image processing apparatus and a method of controlling the same, where in a case where it is not possible to identify the size of an original document to be read by a reading apparatus that scans and reads the original document, the reading apparatus is controlled to read the original document by a maximum reading region of the reading apparatus, image data of the original document is cropped from image data obtained by reading the original document by the maximum reading region, and the cropped image data of the original document is converted to a file.

### BACKGROUND OF THE INVENTION

### Field of the Invention

The present invention relates to an image processing apparatus, and a method of controlling the same.

### Description of the Related Art

Conventionally, a plurality of original documents, such as a document, business card, or a card, which have respectively different sizes are placed in order on a read surface (platen glass) of an image reading apparatus such as a scanner, and these are read as one piece of image data. A technique for cropping the image data for each original document from the image data that was read and obtained is known (multi-crop processing).

In Japanese Patent Laid-Open No. 2009-272678, one set of original documents comprising a plurality of sheets placed in order on a read surface of a reading apparatus is read, and divided into a plurality of pieces of image data by multi-crop processing. A technique for allocating the divided pieces of image data to respective pages, and generating one file that comprises a plurality of pages is recited.

Conventionally, in a case of reading original documents of a nonstandard size such as receipts, business cards, and cards placed on an original document platen, a user needs to explicitly designate a reading setting or a reading mode for reading original documents of a nonstandard size. In other words, in a case of reading an original document of a nonstandard size, because a user needs to explicitly designate the document size, effort for the user occurs each time they cause an original document of a nonstandard size to be read.

### SUMMARY OF THE INVENTION

An aspect of the present invention is to eliminate the above-mentioned problem with conventional technology.

A feature of the present invention is to provide a technique for, in a case where the size of an original document to be read cannot be identified, automatically crop only image data for the original document.

According to a first aspect of the present invention, there is provided an image processing apparatus, comprising: a memory that stores a set of instructions; and at least one processor that executes the instructions to: if a size of an original document to be read by a reading apparatus that scans and reads the original document cannot be identified, control the reading apparatus to read the original document by a maximum reading region of the reading apparatus; crop image data of the original document from image data obtained by reading the original document by the maximum reading region; and convert the cropped image data of the original document to a file.

According to a second aspect of the present invention, there is provided an image processing apparatus, comprising: a reading unit configured to scan and read an original document; a memory that stores a set of instructions; and at least one processor that executes the instructions to: if a size of an original document to be read by the reading unit cannot be identified, control the reading unit to read the original document by a maximum reading region of the reading unit; crop image data of the original document from image data obtained by reading the original document by the maximum reading region; and convert the cropped image data of the original document to a file.

According to a third aspect of the present invention, there is provided a method of controlling an image processing apparatus, the method comprising: if a size of an original document to be read by a reading apparatus that scans and reads the original document cannot be identified, controlling the reading apparatus to read the original document by a maximum reading region of the reading apparatus; cropping image data of the original document from image data obtained by reading the original document by the maximum reading region; and converting the cropped image data of the original document to a file.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a view illustrating an overall configuration of a system according to a first embodiment of the present invention.

FIG. 2 is a block diagram for describing a hardware configuration of an image forming apparatus according to the first embodiment.

FIG. 3 is a block diagram for describing a configuration of an image processing function of the image forming apparatus according to the first embodiment and a flow of its processing.

FIG. 4 depicts a view illustrating an arrangement example of an original document on a platen glass when an original document of a nonstandard size is scanned with a scanner of the image forming apparatus according to the first embodiment.

FIG. 5 depicts a view illustrating image data that the scanner of the image forming apparatus according to the first embodiment obtains by reading an original document of a nonstandard size.

FIGS. 6A through 6C depict views illustrating examples of screens that displayed on a display/console unit of the image forming apparatus according to the first embodiment.

FIG. 7 depicts a view illustrating an example of an image of an image file that is generated based on image data that is obtained by the scanner of the image forming apparatus according to the first embodiment.

FIG. 8 is a block diagram for describing a configuration of an image processing function of the image forming apparatus according to a second embodiment and a flow of its processing.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

Note that, in the embodiments described below, description is given by taking an image forming apparatus 100 such as a multi-function peripheral as an example of an image processing apparatus according to the present invention, but there is no limitation to this, and application is also possible to a portable terminal device, an information processing apparatus such as a PC or a communication apparatus, or the like, for example.

### First Embodiment

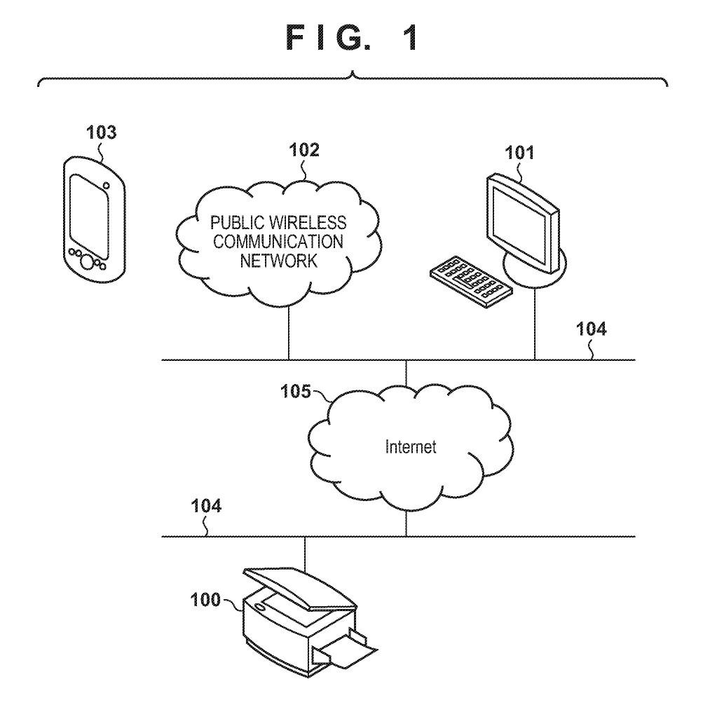

FIG. 1 depicts a view illustrating a overall configuration of a system according to the first embodiment of the present invention.

Here, an image forming apparatus 100 and a terminal 101 which is a PC or the like are connected to a LAN 104 comprising Ethernet (registered trademark), a wireless LAN or the like, and is also connected with the Internet 105. Additionally, a mobile terminal 103 is connected to the Internet 105 via a public wireless communication network 102. The image forming apparatus 100, the terminal 101 which is a PC or the like, and the mobile terminal 103 are connected with the LAN 104 or the Internet 105 via the public wireless communication network 102, and can communicate with each other. Note that there may be a configuration where only one of the mobile terminal 103 and the terminal 101 which is a PC or the like is present, and there may be a configuration where neither are present.

The image forming apparatus 100 is a multi-function peripheral that includes a console unit, a scanner, and a printer. In a system according to the first embodiment, the image forming apparatus 100 is used as a scan terminal for a plurality of original documents of a nonstandard size, or original documents of a standard size. In addition, the image forming apparatus 100 has a display unit such as a UI (a user interface) and a console unit such as a touch panel or hard buttons, and performs display such as an error notification or an instruction notification, and accepts an operation by a user such as a scan operation or a setting operation. Additionally, configuration may be such that the image forming apparatus 100 does not have a scanner but is connected to a scanner device.

The terminal 101 which is a PC or the like performs a display of an image based on image data that is obtained by the image forming apparatus 100. Additionally, the terminal 101 includes a PC application or the like, and saves files obtained from the image forming apparatus 100. Furthermore, the terminal 101 can communicate with an external storage such as a cloud or a server, and can also send a saved file to the external storage. Note that, in the first embodiment, while the terminal 101 which is a PC or the like can save a file or send it to an external storage, the image forming apparatus 100 has similar functionality, and such processing can also be performed by the image forming apparatus 100 on its own.

In addition, the mobile terminal 103 is a smart phone or a tablet terminal that has an operation unit, a wireless communication unit, and an application unit for causing a Web browser to operate. In a system according to the first embodiment, the mobile terminal 103 can be used as a display terminal, an operation terminal, or a file saving terminal, similarly to the terminal 101 which is a PC or the like. Note that the terminal 101 and the mobile terminal 103 have duplicate functionality such as display, operation, and file saving functionality, and although it is possible to use the functionality of both, either one may be used.

The configuration described above is at most an example, and does not mean that the entirety of the configuration is necessary. For example, it is possible to realize functionality according to the embodiment by only the image forming apparatus 100 if the image forming apparatus 100 has a file saving function and a function for transmission to an external storage, in addition to a scanning function for reading an original document and a display/console function.

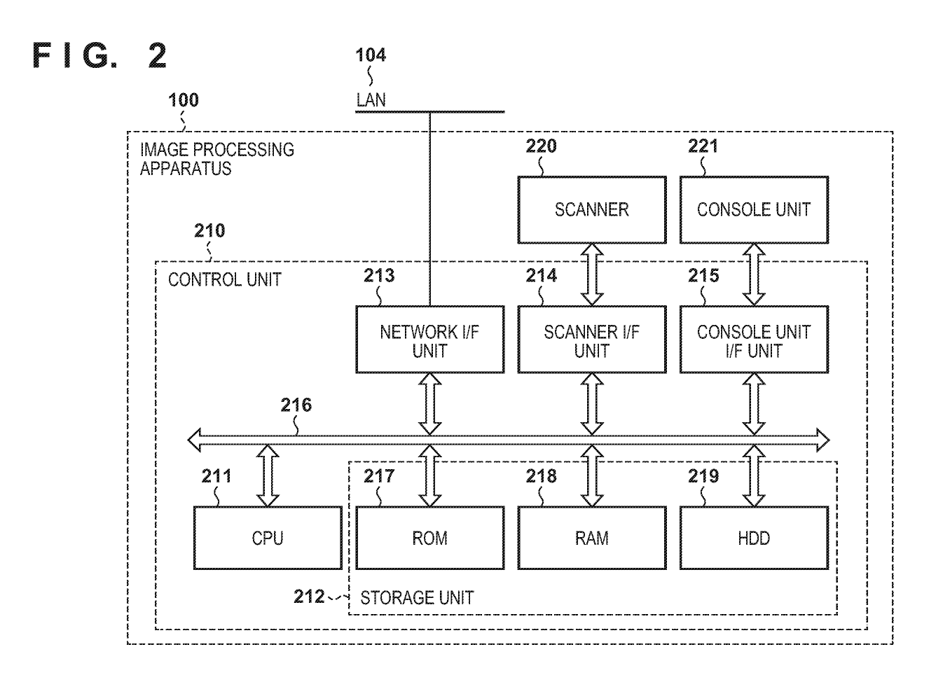

FIG. 2 is a block diagram for describing a hardware configuration of the image forming apparatus 100 according to the first embodiment.

A control unit 210 includes a CPU 211, a storage unit 212, a network I/F unit 213, a scanner I/F unit 214 and a console unit interface 215 and these are communicably connected to each other via a system bus 216. The control unit 210 controls operation of the image forming apparatus 100 as a whole. The CPU 211 reads a control program that is stored in the storage unit 212 and performs various controls such as reading control or transmission control. The storage unit 212 stores and holds the above-described program, image data, setting data, and processing result data or the like. The storage unit 212 includes a ROM 217 that is a non-volatile memory, a RAM 218 that is a volatile memory, an HDD 219 that is large-capacity storage region, or the like. The CPU 211 executes a boot program that is stored in the ROM 217, to deploy a control program that is stored in the HDD 219 or the like to the RAM 218, and performs various control such as reading control or transmission control by executing the deployed program. Additionally, the RAM 218 is used as a temporary storage region for a main memory or work area of the CPU 211.

The network I/F unit 213 connects the control unit 210 (the image forming apparatus 100) to the LAN 104. The network I/F unit 213 sends image data to an external apparatus (the terminal 101 which is a PC or the like or the mobile terminal 103 in the case of the first embodiment) on the LAN 104 and receives various information from the external apparatus on the LAN 104. The scanner I/F unit 214 connects a scanner 220 and the control unit 210. The scanner 220 reads an image of an original document, generates image data, and then inputs the data into the control unit 210 via the scanner I/F unit 214. The console unit interface 215 connects a console unit 221 and the control unit 210. The console unit 221 is provided with a keyboard, a display unit that includes a touch panel function, or the like. In addition, the image forming apparatus 100 includes a printer or the like, but description thereof is omitted in the first embodiment.

In this way, the image forming apparatus 100 according to the first embodiment provides an image processing function by the above-described hardware configuration.

Hereinafter, the image processing function of the image forming apparatus 100 according to the first embodiment and a flow of the processing is described.

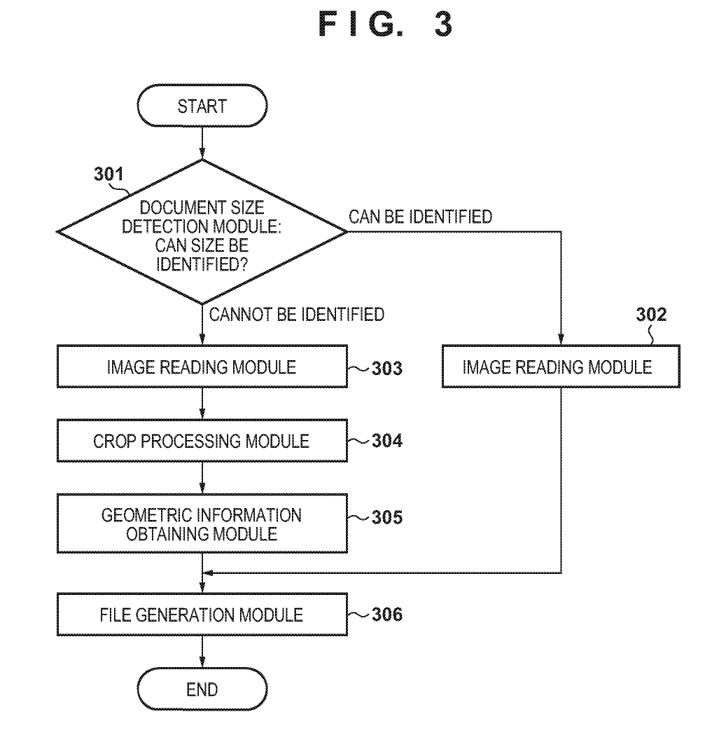

FIG. 3 is a block diagram for describing a configuration of an image processing function of the image forming apparatus 100 according to the first embodiment and a flow of its processing. The image forming apparatus 100 according to the first embodiment primarily includes a document size detection module 301, image reading modules 302 and 303, a crop processing module 304, a geometric information obtaining module 305, and a file generation module 306. Note, a functions of each module is achieved by executing a program that the CPU 211 deployed to the RAM 218.

First, the document size detection module 301 detects an original document size based on information of a sensor that the scanner 220 sets when the original document is placed on the scanner 220. Note, this sensor is assumed to be able to detect (identify) the size when the original document size is a standard size and be not able to identify the size when the original document size is not a standard size.

In this way, when the document size detection module 301 can identify the size of the original document, the image reading module 302 reads the original document in accordance with the identified size of the original document, and obtains the image data from the scanner 220. Accordingly, the original document that is placed on a surface of a reading glass (platen glass) of the scanner 220 is read and an image of the original document can be obtained as a bitmap data image.

On the other hand, when the document size detection module 301 cannot detect the original document size or when the original document size cannot be identified, the image reading module 303 obtains image data for a maximum scanning size (maximum reading region) that the scanner 220 scans. At this time, the scanner 220 scans a region equivalent to the maximum scanning size on a reading glass surface on which the original document is placed to generate bitmap data. The image data generated in this way is stored in the HDD 219 of the image forming apparatus 100.

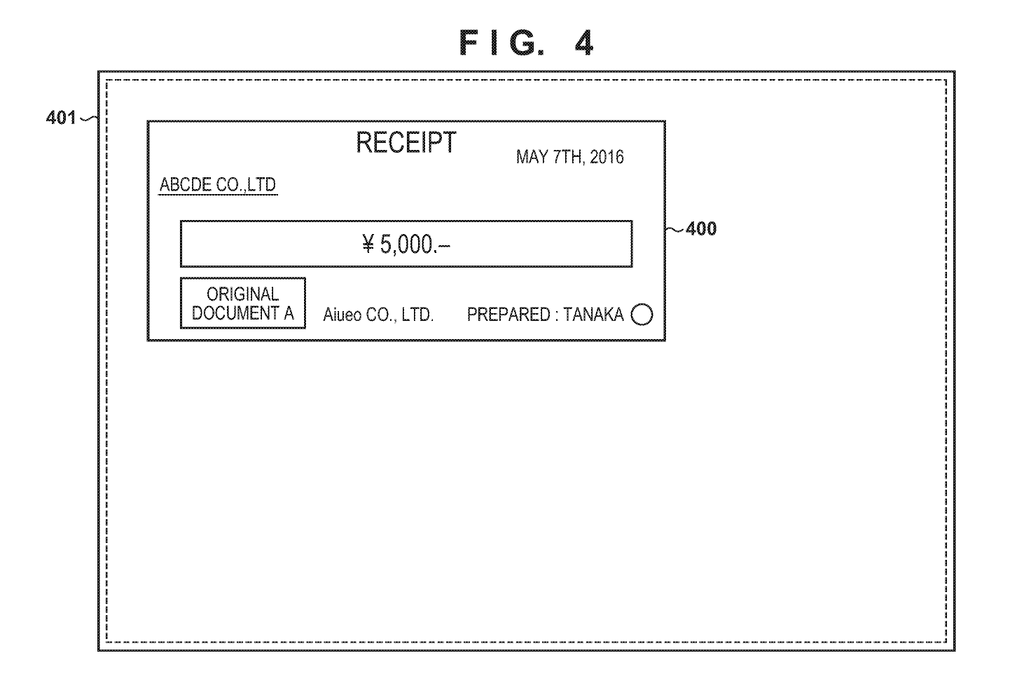

FIG. 4 depicts a view illustrating an arrangement example of an original document on a platen glass when an original document of a nonstandard size is scanned with the scanner 220 of the image forming apparatus 100 according to the first embodiment.

This illustrates an arrangement example of the original document when the image reading module 303 reads the original document. Here, the read surface of the scanner 220 has a region 401 of a maximum scanning size for A3 for example, and an original document to be read is placed on this read surface. As an original document placed here, an original document such as an original document 400 (for example, a business card or a card) having a nonstandard size, for example, is envisioned. Note that, in the first embodiment, the original document 400 is envisioned as a business card or a card, but it may be any original document of a nonstandard size if its size cannot be detected by the document size detection module 301.

Next, the crop processing module 304 obtains the image data that is stored in the HDD 219. The CPU 211 of the image forming apparatus 100 functions as the crop processing module 304, recognizes an original document region from the image data, and crops the image data in accordance with the recognized original document region. As a result, the image reading module 303 can obtain image data of the original document of the nonstandard size included in the image data of the maximum scanning size that was read and obtained.

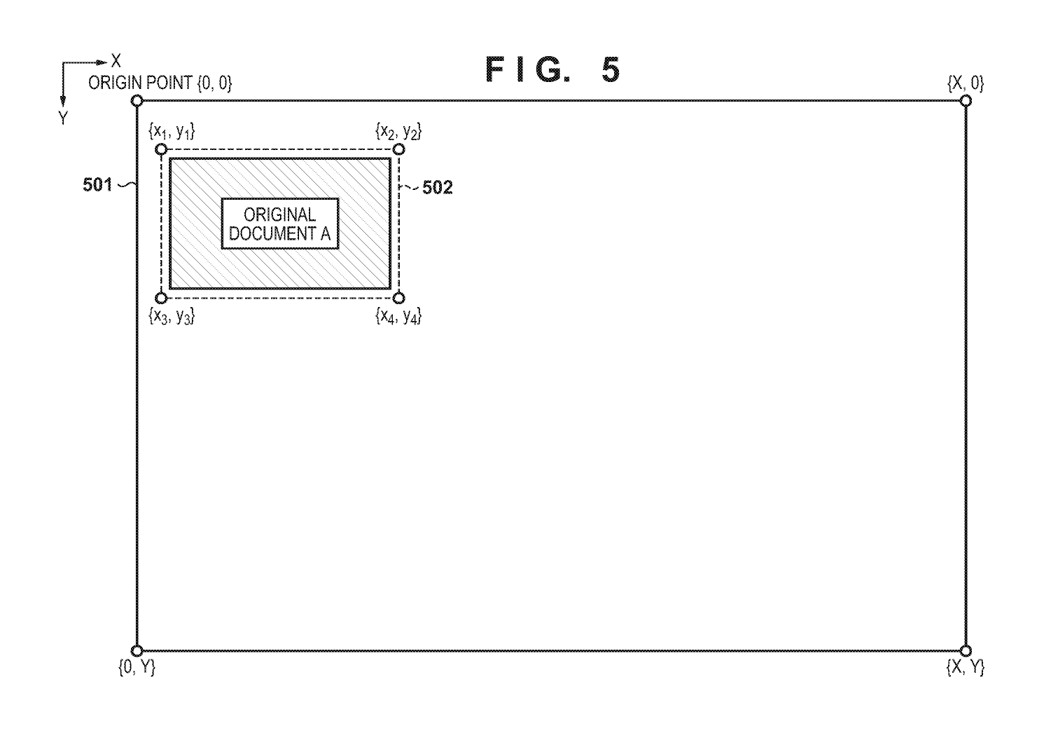

Description regarding to the image data that is read/obtained by the image reading module 303 for the maximum scanning size will be given with reference to FIG. 5.

FIG. 5 depicts a view illustrating image data obtained by the scanner 220 of the image forming apparatus 100 according to the first embodiment reading an original document of a nonstandard size.

Image data 501 indicates the entirety of image data corresponding to a region having the maximum scanning size, and is image data with a width of X pixels and a height of Y pixels, with an origin point in the top left. The region of the original document is extracted from the image data 501 to obtain image data 502 for the region of the original document (the original document A). Crop processing for extracting only the image data 502 for the original document from the image data 501 read and obtained by the image reading module 303 uses a method for cropping a rectangular region based on frame edges of the original document. Note that the crop processing is also referred to as trimming and can be realized using a known technique. The image data of the original document after crop processing is stored in the HDD 219 of the image forming apparatus 100. The foregoing is the processing of the crop processing module 304.

The geometric information obtaining module 305 obtains an area of the cropped image data of the original document, and position coordinates of the image data of the original document on the read image data. Here, the functionality of the geometric information obtaining module 305 is realized by the CPU 211 of the image forming apparatus 100 functioning as the geometric information obtaining module 305. Note that the processing of the geometric information obtaining module 305 can be performed at the same time as the processing of the crop processing module 304.

As illustrated by FIG. 5, it is possible to obtain coordinate values of four vertices for the image of the original document at the same time. In the first embodiment, in the case of the original document (the original document A) 400 of FIG. 4, coordinate values for the four corners are obtained: a top-left vertex (x1, y1), a top-right vertex (x2, y2), a bottom-left vertex (x3, y3), and a bottom-right vertex (x4, y4). In addition, the width and the height of the original document are calculated from the obtained coordinate values of the four vertices. As a calculation method, calculation is possible by the following Equation (1) in the case where the original document is placed parallel to a main scanning direction of the scanner 220.

Width:W=x2−x1

Height:H=y3−y1 Equation (1)

However, because there are many cases where the original document is not placed parallel to the main scanning direction of the scanner 220, calculation is possible by the following Equation (2) in such cases.

Width:W=√{(x2−x1)²+(y2−y1)²}

Height:H=√{(x3−x1)²+(y3−y1)²} Equation (2)

The method for calculating the width and height of the original document indicated above calculates the width of the original document as the length of a top border, and the height of the original document as the length of a left border. In addition, configuration may be taken to use a method in which the coordinate values of the bottom-right vertex (x4, y4) are used to obtain the width of the original document by using an average of the lengths of the top border and the bottom border, for example, or whichever is the larger value.

In addition, configuration may be taken to use a method in which the height of the original document uses the average of the lengths of the left border and the right border, or the value of whichever is larger. The area (size) of the image is calculated based on the calculated width and height. This is derived by multiplying the width and the height. Note that a method of calculating the area is not particularly limited if it is a method for calculating the area of a region that is surrounded by the four vertices.

Numerical data such as the coordinate values, width, height, and area obtained and calculated by the geometric information obtaining module 305 in this way is saved together with the image data of a respective original document in the HDD 219 of the image forming apparatus 100 linked to the image data. Also, regarding a save destination of the image data, the data may be stored in the RAM 218 of the storage unit 212. The foregoing is the processing of the geometric information obtaining module 305.

The file generation module 306 generates a file from image data stored in the HDD 219 by the CPU 211 of the image forming apparatus 100 executing a program to function as the file generation module 306. For example, PDF (Portable Document Format), XPS (XML Paper Specification), JPEG, or the like may be given as a format to generate. When generating files of these formats, the image data of the original document that was cropped by the crop processing is stored in a predetermined folder.

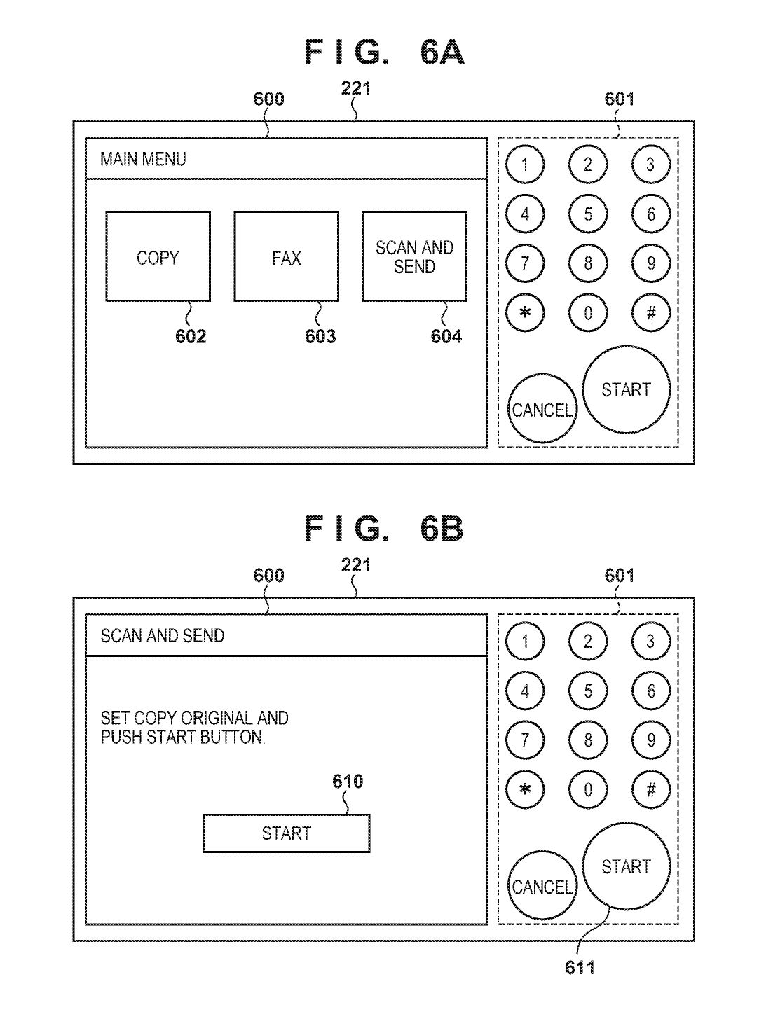

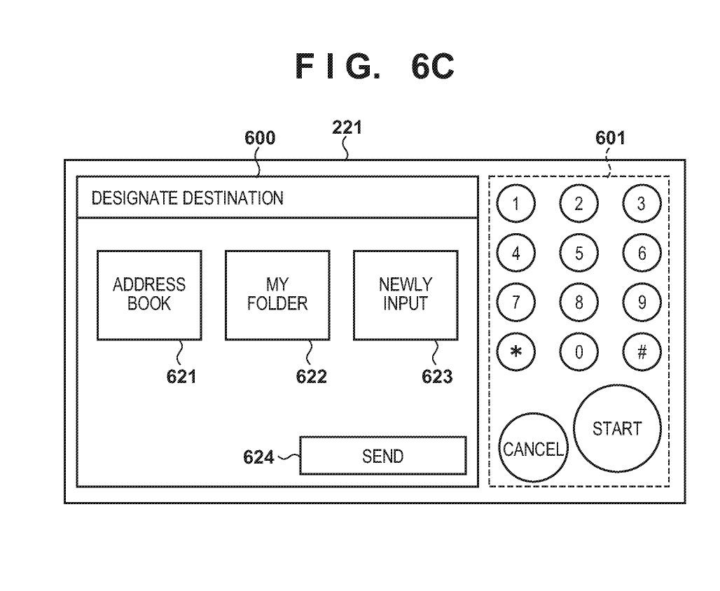

FIGS. 6A through 6C depict views illustrating examples of screens that displayed on the display/console unit 221 of the image forming apparatus 100 according to the first embodiment.

The display/console unit 221 includes a display unit 600 that displays a UI screen (has a display function and an operation function) and a key operation unit 601 that includes physical keys. FIG. 6A illustrates an example of a main menu screen that is displayed on the display unit 600. This menu screen includes a copy button 602 for calling a copy function of the image forming apparatus 100, a FAX button 603 for calling a facsimile function, and a “scan and send” button 604 for scanning an original document using the scanner 220 and sending an obtained image.

FIG. 6B illustrates a top screen for “scan and send” that is transitioned to and displayed by the “scan and send” button 604 being pressed on the menu screen of FIG. 6A. Here, after a user places an original document on the original document platen of the scanner 220 and presses a start button 610 or a start key 611, reading of the original document by the scanner 220 starts.

FIG. 6C illustrates a screen that lets a user designate an address that the image file is sent to after the original document reading is completed. Note, configuration may be taken so that to display the screen of FIG. 6C for designating an address before the top screen for “scan and send” of FIG. 6B. The screen of FIG. 6C includes a button 621 for selecting the address from an address book, a button 622 for setting My Folder as the address, and button 623 for setting an address that is newly inputted. After an address is set in this screen, the image file of the original document is sent to the designated address when the send button 624 is pressed.

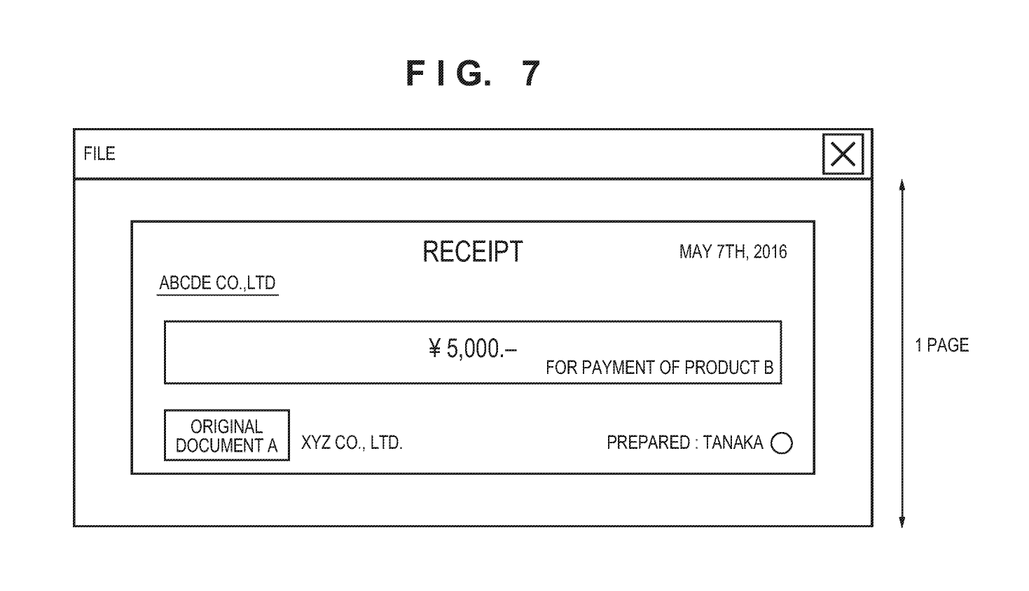

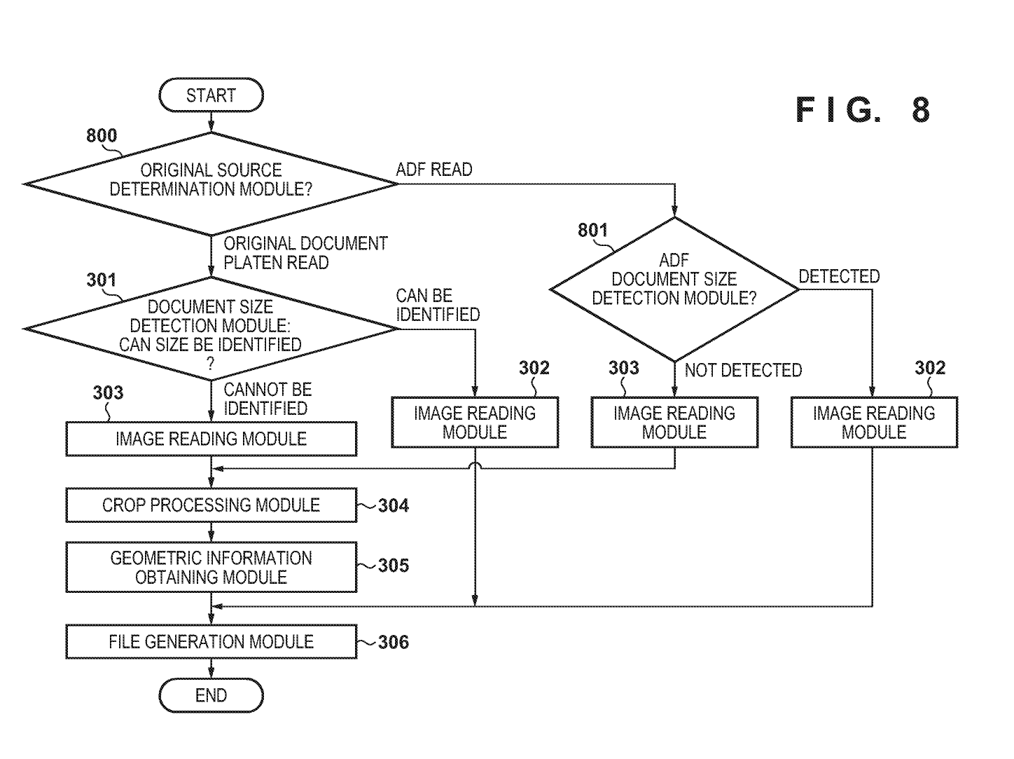

FIG. 7 depict a view illustrating an example of an image of an image file that is generated based on image data that is obtained by the scanner 220 of the image forming apparatus 100 according to the first embodiment.

A file that includes the image data of an original document (an original document A) that is cropped by the crop processing module 304 is generated. The foregoing is the processing of the file generation module 306.

A file generated by the file generation module 306 in this way may be saved in the HDD 219 of the image forming apparatus 100, or the image file may be sent to the mobile terminal 103 or the terminal 101 which is a PC or the like.

By virtue of the first embodiment as described above, it is possible to read an original document of a nonstandard size placed on an original document platen, and, from that image data, to crop and convert image data of the original document into a file.

### Second Embodiment

In the first embodiment described above, when an original document placed on the original document platen of the scanner 220 is read, processing for reading the original document is switched in accordance with whether or not the size of the original document can be detected. Description was given of an example where, in a case where the size of the original document could not be identified, it is possible to automatically crop and make a conversion to a file, even for image data of an original document of a nonstandard size, by performing crop processing to crop image data for the original document.

However, the scanner 220 can also read an original document by using an auto document feeder (hereinafter, ADF) instead of simply scanning the original document platen. Accordingly, in the second embodiment, description is given by an example of performing processing in accordance with a case of reading an original document placed on the original document platen, and a case of reading an original document fed from the ADF. Note that the system configuration and the hardware configuration of the image forming apparatus 100 according to a second embodiment are the same as in the previously described first embodiment, and so description thereof will be omitted.

FIG. 8 is a block diagram for describing a configuration of an image processing function of the image forming apparatus 100 according to the second embodiment and a flow of its processing. Note that in FIG. 8, portions that are common to the previously described FIG. 3 are indicated by the same reference numerals, and description thereof is omitted.

An original source determination module 800 determines whether the scanner 220 of the image forming apparatus 100 is to read an original document fed from the ADF or to read an original document placed on the original document platen. As a method for this determination, assume that reading an original document from the ADF is performed when a sensor (not shown), for detecting that an original document is placed on the ADF, detects an original document. In contrast, a determination to read an original document placed on the original document platen is made when the sensor does not detect an original document. Note that a method for determining whether an original document is placed on the ADF or an original document is placed on the original document platen can be a well-known method other than what is indicated here.

A case where the original source determination module 800 determines to read an original document placed on the original document platen is the same as details of processing described in the first embodiment which is described above, and thus description thereof is omitted.

Meanwhile, in a case of determining to read an original document from the ADF, an ADF document size detection module 801 detects a size of the original document contained in the ADF. Detection of the size of the original document placed on the ADF uses the sensor (not shown) mounted in the ADF. In addition, it is possible to detect the size of an original document to be read by a well-known method, and such method is not limited.

When the ADF document size detection module 801 cannot detect the size of the original document or when the size of the original document size cannot be identified, the image reading module 303 reads the original document by the maximum scanning size, without relying on the size of the original document. Image data having the maximum scanning size obtained by reading the original document by the image reading module 303 is processed by the crop processing module 304, the geometric information obtaining module 305, and the file generation module 306. The processing in this case is the same as the series of processing by the image reading module 303, the crop processing module 304, the geometric information obtaining module 305, and the file generation module 306 of FIG. 3 of the first embodiment described above, and thus description thereof is omitted.

Meanwhile, in a case where the size of the original document could be identified by the ADF document size detection module 801, reading of the original document is performed by the image reading module 302 based on the identified size. The image data obtained by reading the original document by the image reading module 302 is converted to a file by the file generation module 306. This case is also the same as the details of processing by the image reading module 302 and the file generation module 306 of FIG. 3, and thus description thereof is omitted.

By virtue of the second embodiment as described above, when an original document to be read is fed from the ADF, in a case where the size of the original document cannot be identified, in accordance with reading of the original document at the maximum scanning size and crop processing, image data for the original document is cropped.

### OTHER EMBODIMENTS

Embodiments of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-158138, filed Aug. 18, 2017, which is hereby incorporated by reference herein in its entirety.

What is claimed is:

1. An image processing apparatus, comprising:
a memory that stores a set of instructions; and
at least one processor that executes the instructions to:
if a size of an original document to be read by a reading apparatus that scans and reads the original document cannot be identified, control the reading apparatus to read the original document by a maximum reading region of the reading apparatus;
crop image data of the original document from image data obtained by reading the original document by the maximum reading region; and
convert the cropped image data of the original document to a file.

2. The image processing apparatus according to claim 1, wherein the reading apparatus cannot identify the size of the original document to be read if the size of the original document is not a standard size.

3. The image processing apparatus according to claim 1, wherein the at least one processor executes the instructions further to:
determine whether reading of an original document in the reading apparatus is reading of an original document fed from an auto document feeder, or reading of an original document placed on an original document platen,
wherein the at least one processor, in a case of determining reading of an original document placed on the original document platen and not being able to identify the size of the original document, controls the reading apparatus to read the original document by the maximum reading region of the reading apparatus.

4. An image processing apparatus, comprising:
a reading unit configured to scan and read an original document;
a memory that stores a set of instructions; and
at least one processor that executes the instructions to:
if a size of an original document to be read by the reading unit cannot be identified, control the reading unit to read the original document by a maximum reading region of the reading unit;
crop image data of the original document from image data obtained by reading the original document by the maximum reading region; and
convert the cropped image data of the original document to a file.

5. The image processing apparatus according to claim 4, wherein the reading unit cannot identify the size of the original document to be read if the size of the original document is not a standard size.

6. The image processing apparatus according to claim 4, wherein the at least one processor executes the instructions further to:
obtain a width, height, and/or an area of image data corresponding to the original document.

7. The image processing apparatus according to claim 4, wherein the at least one processor executes the instructions further to:
display a menu screen including a button for instructing reading of an original document by the reading unit,
wherein the at least one processor causes reading of an original document by the reading unit to start in response to an instruction from the displayed button.

8. The image processing apparatus according to claim 4, wherein the at least one processor, in a case where it is possible to identify the size of an original document to be read by the reading unit, controls the reading unit to read the original document in accordance with the size of the original document.

9. The image processing apparatus according to claim 4, wherein the at least one processor executes the instructions further to:
send the image data of the original document that is converted to a file to a designated destination.

10. The image processing apparatus according to claim 4, wherein the at least one processor executes the instructions further to:
cause the image data of the original document that is converted to a file to be saved to a designated destination.

11. The image processing apparatus according to claim 4, wherein the at least one processor executes the instructions further to:
determine whether reading of an original document in the reading unit is reading of an original document fed from an auto document feeder, or reading of an original document placed on an original document platen,
wherein the at least one processor, in a case of determining reading of an original document placed on the original document platen and not being able to identify the size of the original document, controls the reading unit to read the original document by the maximum reading region of the reading unit.

12. A method of controlling an image processing apparatus, the method comprising:
if a size of an original document to be read by a reading apparatus that scans and reads the original document cannot be identified, controlling the reading apparatus to read the original document by a maximum reading region of the reading apparatus;
cropping image data of the original document from image data obtained by reading the original document by the maximum reading region; and
converting the cropped image data of the original document to a file.
